(19) United States
(12) Patent Application Publication
(10) Pub. No.: US 2005/0125213 A1
(43) Pub. Date: Jun. 9, 2005

(54) Apparatus, system, and method for modeling and analyzing a plurality of computing workloads

(76) Inventors: Yin Chen, Sunnyvale, CA (US); Rhonda L. Childress, Austin, TX (US); Catherine Helen Crawford, Carmel, NY (US); Noshir Cavas Wadia, Morgan Hill, CA (US); Peng Ye, Fremont, CA (US)

Correspondence Address: KUNZLER & ASSOCIATES, 8 EAST BROADWAY, SUITE 600, SALT LAKE CITY, UT, 84111, US

(21) Appl. No.: 10/729,362

(22) Filed: Dec. 4, 2003

(51) Int. Cl. G06F 9/45

(52) U.S. Cl. 703/22

(57) ABSTRACT

An apparatus, system, and method are provided for modeling and analyzing a plurality of computing workloads. The apparatus, system, and method include a data collection module for gathering performance data associated with operation of the computer system. A modeling module executes a plurality of models in parallel, in series, or according to a hierarchical relationship. A data analysis module presents analysis data compiled from the modeling module to a user, typically in the form of a graph. And finally, a framework manages the data collection module, the modeling module, and the data analysis module according to a predefined data and model flow.

### CROSS-REFERENCES TO RELATED APPLICATIONS

This application claims priority to U.S. Provisional Patent Application No. 60/______ entitled “A METHOD FOR MODELING AND ANALYSIS OF A PLURALITY OF OPERATIONAL COMPUTING WORKLOADS” and filed on Oct. 14, 2003 for Yin Chen, et. al., attorney docket number SVL920030093US1p, which is incorporated herein by reference.

### BACKGROUND OF THE INVENTION

1. Field of the Invention

The invention relates to computer modeling. Specifically, the invention relates to apparatus, systems, and methods for modeling and analyzing a plurality of computing workloads.

2. Description of the Related Art

High volume computer systems such as eBusiness websites, including web servers, application servers, and database servers find it difficult, however highly desirable, to efficiently meet certain performance metrics or services levels (especially those relating to availability) due to unanticipated changes in workload on the systems.

Such problems often stem from poor, obsolete, or overly cautious capacity planning and the lack of robust performance monitoring tools. The products for monitoring system performance and network usage, needed to satisfy desired quality of service levels are inadequate. Current monitoring systems rely heavily on human operators to make decisions regarding changes to a systems configuration to anticipate future needs. The monitoring systems employ various types of models which make different types of predictions based on various input parameters, both real-time and historical.

Even with human involvement, keeping ahead of changes in usage for a system is difficult, particularly in real time, because of the complexity of the system. These complexities include an ill-configured database management system, an overloaded application server, a slow Web server, an over-utilized data center LAN, a maladjusted load balancing switch, an overworked Internet service provider connection, or the like.

FIG. 1 illustrates a computer system 100 monitored using conventional monitoring tools. The computer system 100 includes one or more web servers 102, one or more application servers 104, one or more database servers 106, and the like. The computer system 100 typically connects to a network 108 for interaction with one or more clients 110. As the computer system 100 operates, a variety of data may be collected, stored, and analyzed on a delayed basis or in real-time. Data such as request rate, availability of certain resources (web pages, database records, storage space, applications), response time in a variety of contexts, dropped connections, number of requests queued, average service time, and the like.

Generally, this data is collected and analyzed by one or more monitoring tools specially designed to model a specific aspect of the computer system 100. Typically, it is desirable to monitor and model at least three different types of features of the computer system 100.

The first feature is the predicted load that the computer system 100 will experience in the short or long term. Generally, a load prediction tool 112 collects data relating to the current and historical workload experienced by the computer system 100. From this data, the load prediction tool 112 forecasts the future load for the next few hours, days, or weeks.

Next, a performance analysis tool 114 monitors the current status of the computer system 100. The performance analysis tool 114 collects information such as current response times, failed transactions, resource usage, and the like. From this information, the performance analysis tool 114 is able to provide a notification when the computer system's performance does not satisfy predefined thresholds.

An optimization tool 116 typically reviews historical performance information and what-if information relating to possible future loads. From this information, the optimization tool 116 provides suggestions for changes to the computer system 100 to more efficiently meet the future expected demands.

The load prediction tool 112, performance analysis tool 114, and optimization tool 116 typically operate independently in monitoring and modeling the computer system 100. Consequently, information systems managers must deduce usage trends after operating each tool 112, 114, 116 and decide whether to upgrade server hardware, divide applications among a couple of DBMS, change backbone configurations, move content closer to repeat users, or the like.

Each tool 112, 114, 116 includes its own model specifically configured for the purpose of the tool. For example, the load prediction tool 112 may utilize a time series model such as a Box-Jenkins. The performance analysis tool 114 may use a queuing system model. The optimization tool 116 may use yet a completely different type of model.

Unfortunately, conventional monitoring and modeling tools (i.e. 112, 114, 116) do not readily cooperate and coordinate operation such that output information from one tool 112 feeds readily into another tool 114. This can be caused by proprietary file formats, insufficient output data, differences in measurement units, differences in operation times, and failure of the tools 112, 114, 116 to communicate with each other. These incompatibilities function as barriers 118 preventing effective analysis of a computer system 100 from beginning to end, workload prediction to system optimization.

These barriers 118 also prevent integration of certain models for analysis based on what-if scenarios run in parallel. Furthermore, it can be desirable to organize models into a hierarchy in which a first model produces outputs which are fed into a second model. In this manner, results from the second model may be more accurate and useful. For example, the optimization tool 116 may be more accurate if workload prediction data and performance data streamed directly from the load prediction tool 112 and performance analysis tool 114 into the optimization tool 116.

Typically, conventional tools 112, 114, and 116 are separate software applications. Consequently, although computer system monitoring and analysis systems exist, the benefits of the conventional tools 112, 114, and 116 can not be utilized by the existing monitoring and analysis systems because the software applications are separate and the conventional tools 112, 114, and 116 do not generally support inter-software application communication. Separate conventional tools 112, 114, and 116 prevent use of an autonomous management system for the computer system 100.

In addition, conventional tools 112, 114, and 116 are highly specialized for particular hardware platforms, operating systems, type of system workload, and even computer system 100 configuration. Consequently, specific versions of the tools 112, 114, 116 may be required for one computer system 100 that are different than those for a second computer system.

Accordingly, a need exists for an apparatus, system, and method for modeling and analyzing a plurality of computing workloads. The apparatus, system, and method should allow modeling and analyzing using a plurality of models organized to be executed independently, in parallel, or in a hierarchical relationship. In addition, the apparatus, system, and method should support integration of various types of computer system modeling in a single software application. The apparatus, system, and method should also provide a hardware and operating system independent framework which allows other software programs to invoke one or more model and data flows for a computer system as desired.

### SUMMARY OF THE INVENTION

The present invention has been developed in response to the present state of the art, and in particular, in response to the problems and needs in the art that have not yet been met for modeling and analyzing a plurality of computing workloads. Accordingly, the present invention has been developed to provide an apparatus, system, and method for modeling and analyzing a plurality of computing workloads that overcome many or all of the above-discussed shortcomings in the art.

An apparatus according to the present invention includes a data collection module, a modeling module, a data analysis module, and a framework. The data collection module gathers performance data associated with operation of the computer system. The data collection module may gather historical performance data or real time performance data. The data collection module may gather performance data during operation of the computer system while imposing minimal impact on the performance of the computer system.

The modeling module executes at least one model that utilizes the performance data. Often the modeling module executes a plurality of models. The models may be executed in parallel or in series. In series, one model may produce outputs that serve as inputs to a second model. In this manner, a hierarchy of models may be executed. The modeling module may execute the models in response to an event or on a polling schedule.

The data analysis module presents analysis data compiled from the modeling module. In one embodiment, the analysis data is presented visually in the form of a graph. Alternatively, the analysis data may be presented in the form of a report, raw data values, summary data, and the like.

The framework manages the data collection module, the modeling module, and the data analysis module according to a predefined data and model flow. The framework allows for operation of a predefined data collection module, a predefined modeling module (and/or model), and a predefined data analysis module within a stand-alone application that may include a user interface. Alternatively, the framework may be called from third-party software code to leverage the benefits of the data collection module, the modeling module, and the data analysis module. The framework functions readily with a user-defined data collection module, user-defined model, and/or user defined data analysis module. The framework also allows for a combination of predefined and user defined modules and/or models (data collection, modeling, and data analysis).

The present invention comprises an editor for defining and revising a data and model flow. The editor allows for storage of a data and model flow in a standard format. The editor includes an identification module for providing an identifier of the data and model flow.

In addition, the editor includes a measurement module, a model module, a metric map, and a plot module. The measurement module allows a user to designate a data collection module. The data collection module may be predefined or user-defined. In one embodiment, the data collection module comprises a software class that may be instantiated into a software object configured to serve as the data collection module. The model module allows designation of one or more models that are to be operated on the performance data and/or data from other models.

The metric map allows for defining of model variables and their associated units of measure. The plot module allows for designation of a data analysis module. Like the data collection module, the data analysis module may comprise a class that is later instantiated. The data analysis class may be predefined or user-defined.

The present invention also provides an Application Programming Interface (API) for real-time modeling and analysis of computing workloads. The API includes a measurement software class for gathering performance data associated with operation of a computer system.

The API also includes a workload software class that defines a data and model flow for the computer system. The workload software class includes one or more software classes the user the performance and/or data from one of the other models to model attributes of the computer system. A run-time manager software class in the API may periodically poll for measurement objects instantiated from the measurement software class and execute one or more model objects instantiated from the one or more model software classes. The run-time manager software class may operate according to the data and model flow defined by one or more workload objects.

A method of the present invention is also presented for modeling and analyzing a plurality of computing workloads. In one embodiment, the method includes gathering performance data associated with the operation of a computer system. Next, at least one model that uses the performance data is executed. Analysis data compiled from the at least one model is then presented. Finally, a framework configured to manage gathering of performance data, execution of the at least one model, and presentation of the analysis data in response to a predefined data and model flow is provided.

The present invention may be embodied in a utility program such as a modeling and analysis utility. The modeling and analysis utility provides for collection of performance data according to a data and model flow. The performance data being used to periodically execute one or more models and compile analysis data representative of results from the models. The modeling and analysis utility also allows for presentation of a real-time graphical representation of the analysis data in response to an event. The event may comprise analysis data failing to satisfy a threshold value, a user request, a system event or the like.

The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a conventional system monitored using separate conventional monitoring tools.;

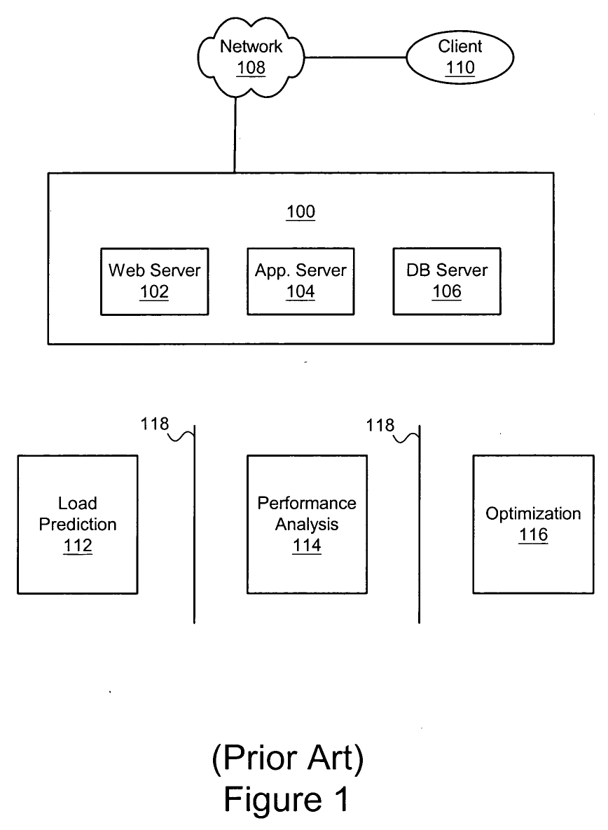

FIG. 2 is a schematic block diagram illustrating one embodiment of an apparatus in accordance with the present invention;

FIG. 3 is a schematic block diagram illustrating a system according to one embodiment of the present invention;

FIG. 4A is a schematic block diagram illustrating a representative example of the architecture provided by one embodiment of the present invention;

FIG. 4B is a schematic block diagram illustrating an example of multi-model monitoring capability provided by the architecture of FIG. 4A;

FIG. 5 is a graphic window illustrating one embodiment of a user interface that may be used to interact with the present invention;

FIG. 6A is a user-interface window illustrating designation of a measurement class according to one embodiment of the present invention;

FIG. 6B is a user-interface window illustrating a top half of a window for designating a model according to one embodiment of the present invention;

FIG. 6C is a user-interface window illustrating a bottom half of a window for designating a model according to one embodiment of the present invention;

FIG. 6D is a user-interface window illustrating defining a metric map according to one embodiment of the present invention;

FIG. 6E is a user-interface window illustrating designation of a plot class according to one embodiment of the present invention; and

FIG. 7 is a flow chart illustrating a method for modeling and analyzing a plurality of computing workloads in accordance with one embodiment of the present invention.

### DETAILED DESCRIPTION OF THE INVENTION

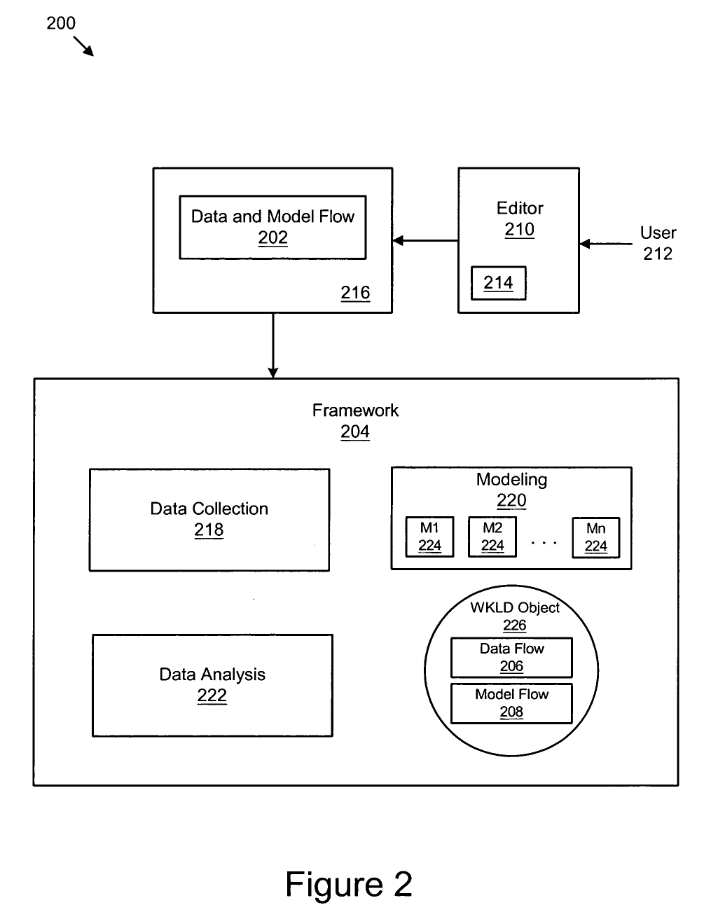

It will be readily understood that the components of the present invention, as generally described and illustrated in the figures herein, may be arranged and designed in a wide variety of different configurations. Thus, the following more detailed description of the embodiments of the apparatus, system, and method of the present invention, as represented in FIGS. 2 through 7, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, a class, an interface, a procedure, a function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

FIG. 2 illustrates a schematic block diagram of one embodiment of an apparatus 200 configured according to the present invention. The apparatus 200 includes a data and model flow 202 and a framework 204. The data and model flow 202 allows monitoring and modeling of a system 100 through many different types of models. The data and model flow 202 allows the models to be identified and the order of operation for the models to be defined. In addition, output data from one model may serve as input data for a second model as directed by the data and model flow 202.

The framework 204 provides an environment for implementing the data and model flow 202. In one embodiment, the framework 204 comprises software that is hardware and operating system independent. This means that the framework 204 may execute any data and model flow 202 on almost any computer hardware and/or operating system having reasonable computing power.

The data and model flow 202 outlines two types of information flows, a data flow 206 and a model flow 208. The data flow 206 identifies the kind of data that will be collected and serve as inputs, how the data is exchanged between one or more models, and the analysis data produced from the models. The model flow 208 identifies an order of operation for models executed by the framework 204 when the data and model flow 202 identifies a plurality of models.

The data and model flow 202 allows for a plurality of models to be executed using a variety of orders of operation. In this manner, a user may monitor and analyze a system 100 using a time series model, a queuing system model, and a global optimization model. The different models may be executed in series, in parallel, or according to a hierarchy outlined by the data and model flow 202. In addition, the monitoring and analysis of a system 100 may be quickly modified to change models, the order of operation for models, the source of input data, the kind of output data, and the like simply by editing the data and model flow 202.

In one embodiment, the data and model flow 202 is defined in a human readable format. The apparatus 200 may include an editor 210 which allows a user 212 to quickly define the data and model flow 202. In one embodiment, the editor 210 comprises a graphical user interface (GUI) organized in an intuitive manner and including help information to guide a user 212 in defining the data and model flow 202.

Using the editor 210, a user 212 defines and revises the data and model flow 202. In certain embodiments, the editor 210 includes a storage module 214 that stores/retrieves the data and model flow 202 to/from a persistent data structure 216. In one embodiment, the persistent data structure 216 is an Extensible Markup Language (XML) file. Alternatively, the persistent data structure 216 may comprise a record or table within a database (not shown).

The framework 204 uses the data and model flow 202 to conduct modeling and analysis of multiple types of computing workloads. As used within this specification, the terms “workload(s)” and “computing workload(s)” refer to any operation tasked to a module, logic unit, processor, or other computational component of an electronic system including but not limited to a personal computer, a server, a mainframe computer, computer sub-system, and the like. The operation may be organized as a specific transaction, task, function, procedure, method, process, or operation.

The framework 204 includes a data collection module 218, a modeling module 220, and a data analysis module 222. The data collection module 218 gathers performance data about the system 100 that is being monitored and analyzed. Performance data includes a variety of information about the operation of the system 100. For example, performance data may include the number of requests per hour or load placed on the system 100, the number of dropped packets, the number of users, the number of page faults, the number of I/O requests, the number of web pages accessed, and the like. The performance data comprises any data relating to the computing load and/or computing performance of the system 100.

In certain embodiments, the data collection module 218 comprises a predefined data collection module 218. The predefined data collection module 218 may include measurement routines, I/O modules, and the like to gather most common types and formats of performance data. For example, a predefined data collection module 218 may include port monitoring routines for capturing the number of web page requests for one or more user-identified URLs. The predefined data collection module 218 may count, compute averages, compute rates, or perform other manipulation of raw data in order to produce performance data.

In addition, the framework 204 supports operation of a user-defined data collection module 218. In one embodiment, the data and model flow 202 determines whether the framework 204 uses a predefined data collection module 218 or a user-defined data collection module 218.

A user-defined data collection module 218 may be written with system 100 specific routines, proprietary data formats, customized data collection and raw data processing routines, and the like. Because the framework 204 supports a user-defined data collection module 218, almost any performance data for almost any system 100 may be gathered. In addition, a user-defined data collection module 218 may be configured to preprocess any raw data or data measurements that are not industry common performance data.

The data collection module 218 (predefined or user-defined) may collect performance data compiled by standard logging or monitoring routines of the system 100. Alternatively, the data collection module 218 may access historical data stored in files or databases as well as real-time performance data for the system 100.

The modeling module 220 executes one or more models 224 (M1, M2, . . . Mn) using performance data as input data. The models 224 are executed as indicated by the data and model flow 202. In one embodiment, the modeling module 220 executes the models 224 each time performance data is provided by the data collection module 218. The data collection module 218 may provide the performance data on a periodic basis, in response to a user command, or another manual or automated schedule. Alternatively, the modeling module 220 may periodically poll the data collection module 218 for updated performance data.

The modeling module 220 may execute the models consecutively in series, in parallel, or according to a hierarchy defined in the data and model flow 202 in which output data from one model serves as input to a second model. In one embodiment, the order of operation and execution sequence for the models 224 is controlled by the data and model flow 202. For example, models 224 identified in the data and model flow 202 may include a sequence number that indicates the order of operation. In addition, common variable names may be used to indicate a model output for a first model 224 that serves as a model input to a second model 224.

Typical models 224 currently exist in both source code and object code form for use in analyzing and monitoring systems 100. These models 224 may be included in a software object that operates the model 224 within the modeling module 202 and framework 204. The modeling module 202 and framework 204 cooperate to execute conventional predefined models 224 such as Box Jenkins and the like as well as user-defined models 224. Support in the framework 204 for user-defined models 224 allows certain embodiments of the present invention to be used by engineers and scientists in industry as well as in research and development to monitor and analyze deployed and prototypical systems 100. Preferably, the present invention supports models 224 from the following groups: workload prediction models, performance analysis models, optimization models, and user-defined models.

The data analysis module 222 presents analysis data compiled from the modeling module 220. In one embodiment, the modeling module 220 compiles result data into analysis data. Alternatively, the data analysis module 222 accepts raw results from modeling module 220 and computes analysis data there from. Analysis data typically includes totals, averages, rates, and other summary type information.

The data analysis module 222 presents the analysis data in a desired format. Preferably, the analysis data is plotted on a graph. The type of graph as well as the axis may be defined in the data and model flow 202. For example, the type of graph may comprise a line graph, a bar chart, a histogram, a scatter plot, and the like. Preferably, the framework 204 includes a plurality of common predefined data analysis modules 222 supporting a variety of common types of graphs and other visual presentation tools for analysis data.

In addition, the framework 204 supports operation of a user-defined data analysis module 222. A user-defined data analysis module 222 may be employed where the analysis data and/or format for the presentation of the data is different than the common graphs and charts used in monitoring and analyzing a system 100. For example, in certain embodiments, a user-defined data analysis module 222 may present one or more reports useful in analyzing and modeling a system 100.

The framework 204 provides a foundation for operation of the data collection module 218, modeling module 220, and data analysis module 222. The framework 204 operates the data collection module 218, modeling module 220, and data analysis module 222 in accordance with the data and model flow 202. The data and model flow 202 define the data flow 206 and model flow 208 as well as identify the collection module 218, modeling module 220 and data analysis module 222. As mentioned, these modules 218, 220, 222 as well as the models 224 may be predefined or user-defined.

The framework 204 may be implemented in various ways. In one embodiment, the framework 204 comprises a collection of object oriented software classes that provide the functionality for operating and managing the data collection module 218, modeling module 220, data analysis module 222, as well as the models 224. Preferably, these classes are defined in a machine and operating system independent object oriented language such as JAVA.

In addition, the data collection module 218, modeling module 220, data analysis module 222, and models 224 may be implemented using software classes or the like. Consequently, the predefined software classes may implement common modeling and analysis functions for the data collection module 218, modeling module 220, data analysis module 222, and models 224. Alternatively, a user 212 may define his/her own data collection module 218, modeling module 220, data analysis module 222, and models 224.

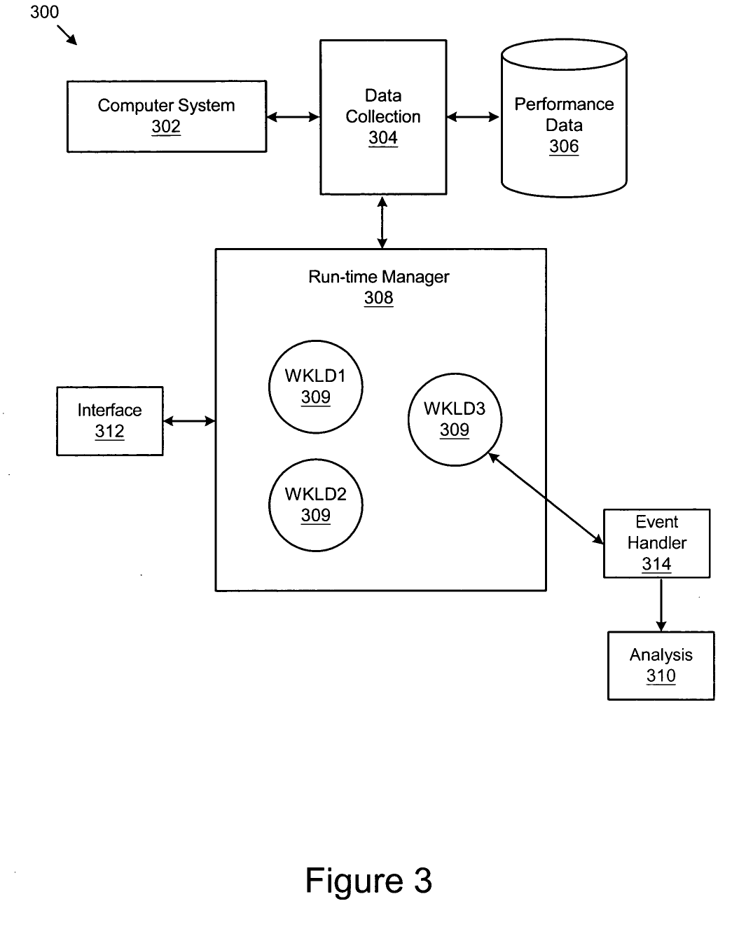

In embodiments where the framework 204, data collection module 218, modeling module 220, data analysis module 222, and models 224 comprise software classes, a user is provided with great flexibility on utilizing the present invention. In one embodiment, the apparatus 200 includes a user interface (Illustrated and discussed in more detail in relation to FIG. 3). The user interface may operate with the framework 204 and a predefined data and model flow 202 to provide a stand-alone application for modeling and analyzing a plurality of computing workloads. Alternatively, an existing software application, a third-party application, may utilize the framework 204, data collection module 218, modeling module 220, data analysis module 222, and models 224 by including and leveraging the predefined software classes that provide the functionality described above.

The framework 204 maintains one or more workload objects 226. The framework 204 is configured to interpret the data and model flow 202 from the persistent data structure 216. From the data and model flow 202, the framework 204 creates an instance of a workload object 226. A workload object 226 includes at least the data flow 206 and the model flow 208 for modeling and analyzing a particular workload of a system 100. In addition, the workload object 226 may include a plurality of methods that perform operations specific to the workload object 226.

The workload object 226 provides a common structure for maintaining the data and model flow 202. The workload object 226 also indicates the input parameters and output parameters for the data collection module 218, modeling module 220, data analysis module 222, and models 224. The workload object 226 may also indicate the data collection module 218, modeling module 220, and data analysis module 222 for use in a specific modeling and analysis study (predefined or user-defined). Because the workload object 226 encapsulates all the information for a specific modeling and analysis study, the framework 204 can support a plurality of modeling and analysis studies by maintaining a plurality of workload objects 226.

It may be desirable to perform modeling and analysis of a system 100 in real-time, on a scheduled basis, or continually such as in an autonomous system. However, the modeling and analysis may be interrupted intentionally or unintentionally. For example, modeling and analysis may be intentionally stopped to perform a backup operation. Accordingly, the workload object 226 may include methods for storing the workload object including any performance data, state information, analysis data, and the data and model flow 202 in persistent storage such as a database.

Those of skill in the art will recognize that the functionality of the components and modules illustrated in FIG. 2 may be implemented in various different combinations of methods, routines, software objects, and the like while not departing from the scope of the present invention. For example, functionality of the modeling module 220 may be implemented in a method of the workload object 226. In addition, a workload object 226 may include methods for providing notifications or triggering other events in response to analysis data satisfying certain thresholds.

FIG. 3 illustrates a system 300 according to one embodiment of the present invention. The system 300 includes a computer system 302 that is to be monitored for modeling and analysis. As mentioned above, the computer system 302 being monitored, modeled, and analyzed may include a plurality of computer systems include server farms, data storage systems, and the like. The present invention may be used with any combination of computer equipment that are organized to provide computing operations include collaborative computer systems such as grid computers.

A data collection module 304 communicates with the computer system 302 being monitored to gather performance data 306 associated with operation of the computer system 302. The data collection module 304 may store the performance data 306 in a persistent repository such as a database. The data collection module 304 takes measurements and collects different performance data relating to the computer system 302 being monitored. In one embodiment, the data collection module 304 is user-defined and specifically configured to gather performance data 306 for a particular computer system 302 being monitored.

The data collection module 304 provides the performance data 306 to a run-time manager 308 in response to a poll inquiry from the run-time manager 308. In one embodiment, the performance data 306 is passed in a data structure such as a software object for example a measurement object. The run-time manager 308 may pass a measurement object to the data collection module 304 periodically to poll for updated performance data 306.

In one embodiment, the run-time manager 308 maintains a plurality of workload object instances 309. A workload object instance 309 is an instantiation of a workload object 226 (See FIG. 2). The run-time manager 308 may cycle through the workload object instances 309 periodically or constantly. For each workload object instance 309 the run-time manager 308 may generate and pass a measurement object to the data collection module 304 associated with a particular workload object instance 309. In one embodiment, each workload object 226 has a unique data collection module 304. If the data collection module 304 provides performance data 306, the run-time manager 308 executes one or more models 224 identified by the workload object instance 309 associated with the data collection module 304 using the performance data. If a data collection module 304 is associated with more than one workload object instance 309, an identifier provided by the data collection module 304 may identify the proper workload object instance 309 for the performance data 306.

The system 300 includes an analysis module 310. The analysis module 310 is configured to present analysis data compiled from the workload object instance 309 in response to an event such as a user request or a system request. In one embodiment, in response to a user request, the analysis module 310 executes a method identified as the data analysis module 222 in the workload object instance 309 to present analysis data to a user.

In one embodiment, the system 300 includes a user interface 312. The user interface 312 allows the system 300 to be operated as a stand-alone software application for modeling and analyzing computing operations for a computer system 302 being monitored. The user interface 312 enables a user 212 to initiate or stop execution of a workload object instance 309 in response to a user request. Consequently, the user 212 may initiate a plurality of workload object instances 309, each configured to execute a plurality of models 224. In this manner, a user 212 may model and analyze a computer system 302 for at least three types of modeling (workload prediction, performance analysis, and optimization) and obtain instant results. In addition, modeling and analysis may be initiated for a plurality of modeling and analysis scenarios (WKLD1, WKLD2, . . . WKLDn).

Of course a variety of events such as a system event may activate the analysis module 310. A system event may comprise an event triggered by a workload object instance 309 according to predefined parameters. In one embodiment, the analysis module 310 is activated by analysis data that fails to satisfy a threshold value defined in the workload object instance 309. Alternatively or in addition, the analysis module 310 is activated according to a time schedule.

In addition to activating the analysis module 310, the system events may trigger remedial actions to prevent future problems for the computer system 302 being monitored. For example, supposed execution of models 224 in a workload object instance 309 indicates that web server traffic is about to dramatically increase above the current capacity of the computer system 302 being monitored. Once the workload object instance 309 detects this condition, an event may be triggered which addresses the potential problem.

In one embodiment, the system 300 includes an event handler 314. The event handler receives notification of the event from the workload object instance 309. If the event is for the analysis module 310, the event handler 314 activates the analysis module 310. If the event is a system event, the event handler 314 takes appropriate action. In the above example, the event handler 314 may bring additional web servers on-line to manage the expected increased need. Preferably, due to the variety of different computer system 302 that may be monitored, the event handler 314 is user-defined.

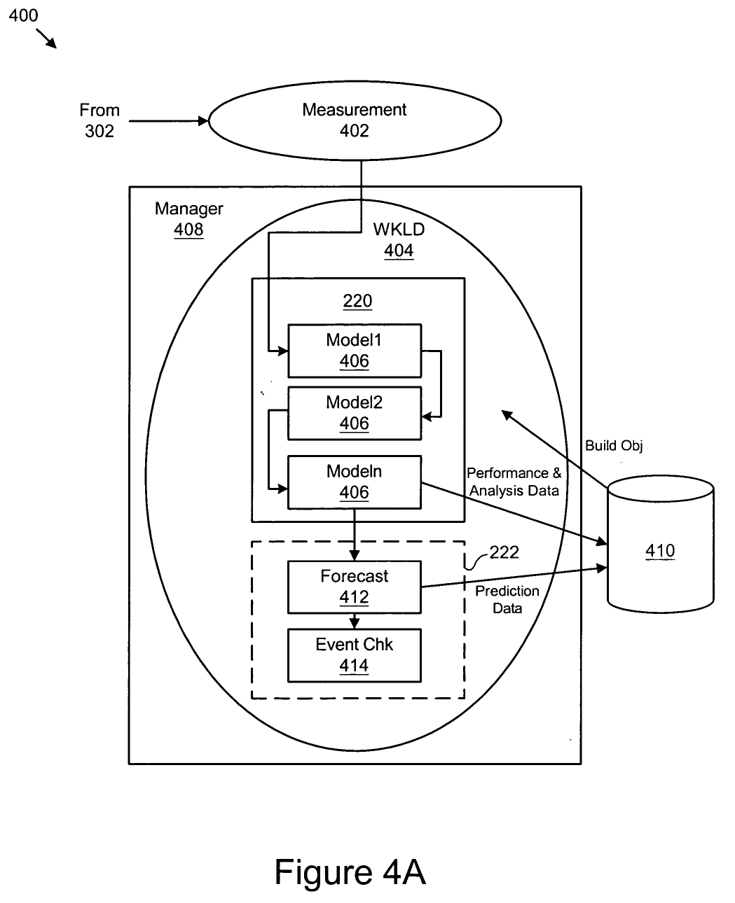

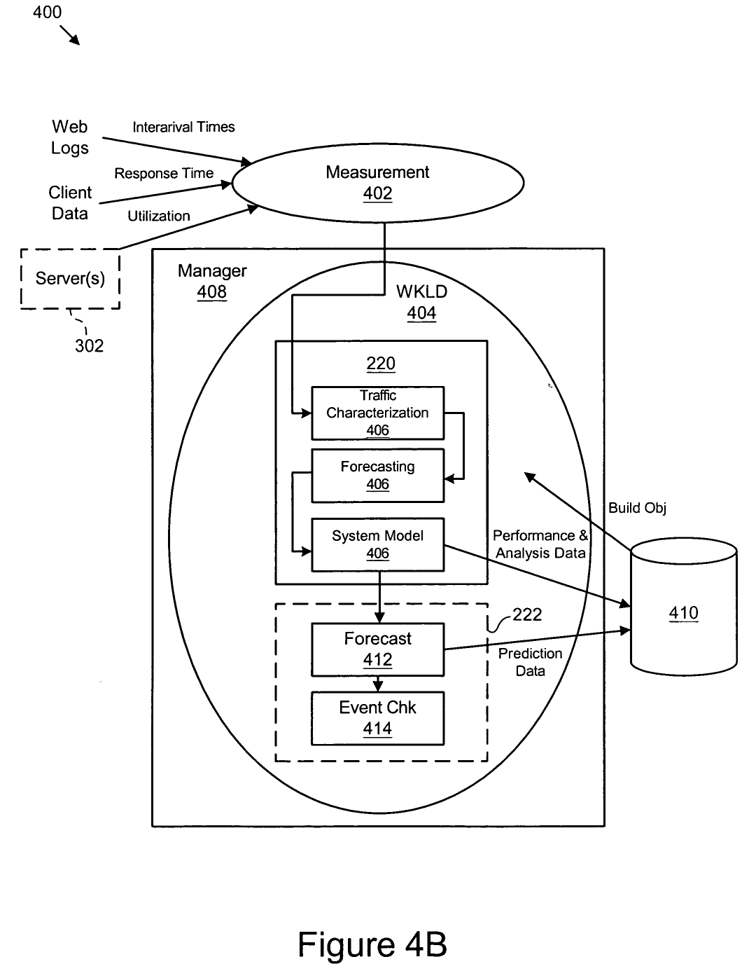

Referring now to FIG. 4A, a representative example of an architecture 400 provided by one embodiment of the present invention is illustrated. The architecture 400 includes substantially the same components illustrated in FIGS. 2 and 3. In one embodiment, the features and functions of the present invention are embodied in an Application Programming Interface (APD. Preferably, the API is written in a machine independent and operating system independent language such as JAVA.

FIG. 4A illustrates major components of the API. Performance data is collected by a measurement class 402. A workload class 404 defines the data and model flow 202 associated with a computer system 302 that is to be monitored. The workload class 404 is configured to include a plurality of models 406. Preferably, one or more model classes 406 implement and define the models 224 (See FIG. 2). In one embodiment, object code from a predefined or user-defined model 224 is wrapped in a model class 406 of the present invention for use in a workload object instance 309 (See FIG. 3) instantiated from a workload object 226 (See FIG. 2).

A run-time manager class 408 periodically polls the measurement object (instantiated from the measurement class 402) and executes one or more model objects of the workload object 404 according to a data and model flow 202 (See FIG. 2) implemented in the modeling module 220 (See FIG. 2). Each software object is instantiated from a corresponding software class. The run-time manager class 408 is configured to generate a workload object instance 309 (See FIG. 3) representative of a workload object 226 (See FIG. 2) from a definition stored in a persistent data structure such as an XML file or database 410.

Typically, monitoring and modeling of a computer system to improve performance receives secondary consideration behind the immediate purposes of the computer system 302. Consequently, it is desirable that monitoring and modeling components be persistent and easily interruptible. In addition, certain models 224 (See FIG. 2) implemented by the model classes 406 use real-time and historical data to improve accuracy.

The present invention provides these desired features by providing a persistent workload class 404 that implements a workload object 226 (See FIG. 2). As a workload object instance 309 (See FIG. 3) executes, the workload object instance 309 may store performance data, analysis data, intermediate model data, historical data, state information, prediction data, and the like in a database 410.

The workload class 404 may include a forecast method 412 and an event check method 414. The forecast method 412 predicts the status of the computer system 302 in the future based on the results of the plurality of models 224 (See FIG. 2) implemented by the model classes 406. The event check method 414 determines whether values forecasted satisfy threshold values such that an event, such as a user notification, should be triggered. Together the forecast method and event check method 414 cooperate to implement an analysis module 222.

FIG. 4B illustrates an example of objects that may be instantiated according to the class architecture illustrated in FIG. 4A. In this example, the computer system 302 being monitored comprises a set of servers. The measurement object (instantiated from the measurement class 402) implements a data collection module 218 (See FIG. 2). The run-time manager class 408 is instantiated as a run-time manager 308 (See FIG. 3). The workload class 404 is instantiated to represent a workload object 226 (See FIG. 2). The model classes 406 are instatiated to create objects implementing models 224 such as a traffic characterization model, a forecasting model, and a system model. The forecast method and event check method cooperate to serve as the analysis module 222.

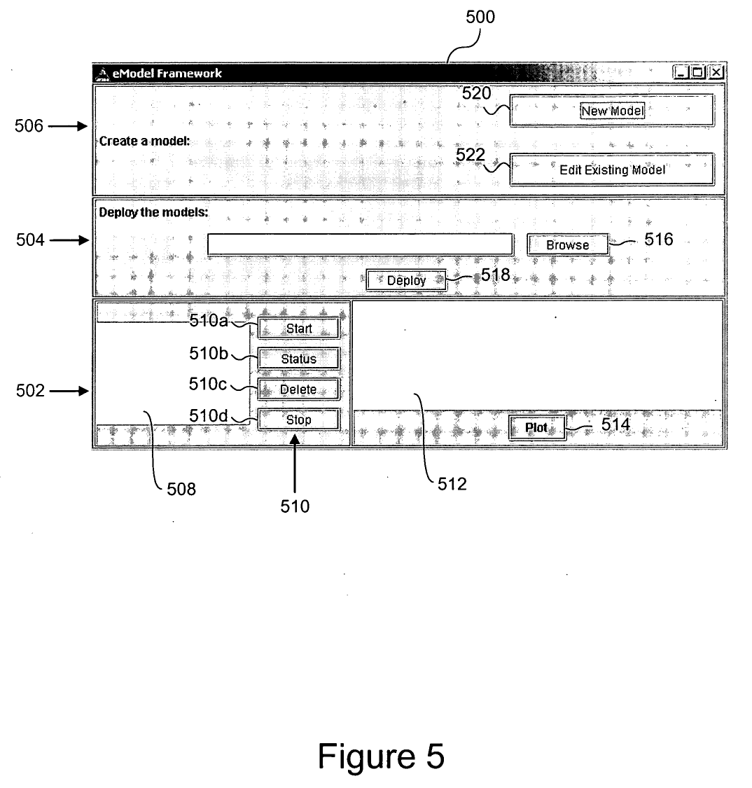

FIG. 5 illustrates a window 500 for one embodiment of a user interface 312 (See FIG. 3) according to one embodiment of the present invention. The user interface 312 allows a user to stop and start execution of one or more workload objects 226 (See FIG. 2) in real-time (i.e. a real-time interface module). In addition, the user interface 312 allows a user to define a new workload object 226 or revise an existing workload object 226. However, to avoid confusing a user 212, the user interface 312 refers only to a model which include one or more models. Consequently, references to ‘model’ on the window 500 typically refer to workload objects 226 which comprise a modeling and analysis study using one or more models 224.

The user interface 312 includes three main sections: workload object management 502, workload object deployment 504, and workload object configuration 506. The workload object management section 502 comprises a list pane 508 and a set of buttons 510. The list pane 508 (illustrated empty) lists a plurality of workload objects 226 that are currently configured for use in the user interface 312. A start button 510a allows a user to start execution of a workload object 226 selected in the list pane 508. A status button 510b displays a pop-up window indicating whether a selected workload object 226 is started or stopped. A delete button 510c deletes the definition of a selected workload object 226 from persistent storage. A stop button 510d allows a user 212 to stop execution of a workload object 226 selected in the list pane 508.

The workload object management section 502 includes a graph pane 512 and a plot button 514. Once a workload object 226 is selected in the list pane 508, a graph associated with the workload object 226 is displayed in the graph pane 512 in response to activation of the plot button 514. The graph is generated by a plot object instantiated from a plot class identified in the workload object 226. The plot object plots the graph according to the parameters, axis, and graph type as identified in the data and model flow 202.

As mentioned above, workload objects 226 may be stored in a database 410. The workload object deployment section 504 allows a user to select a predefined workload object 226 and store the object in a database 410. Preferably, the user 212 selects a source XML file that represents the workload object 226 using the browse button 516. Next, once the deploy button 518 is activated, the workload object 226 is stored in a predefined database 410.

In the workload object configuration section 506, the user 212 may activate a new model button 520 or an edit existing model button 522. If button 522 is selected, a user 212 may be provided with a choice of workload objects 226 to select from for editing and then an editor 600 is opened. If button 520 is activated, the editor 600 is immediately opened.

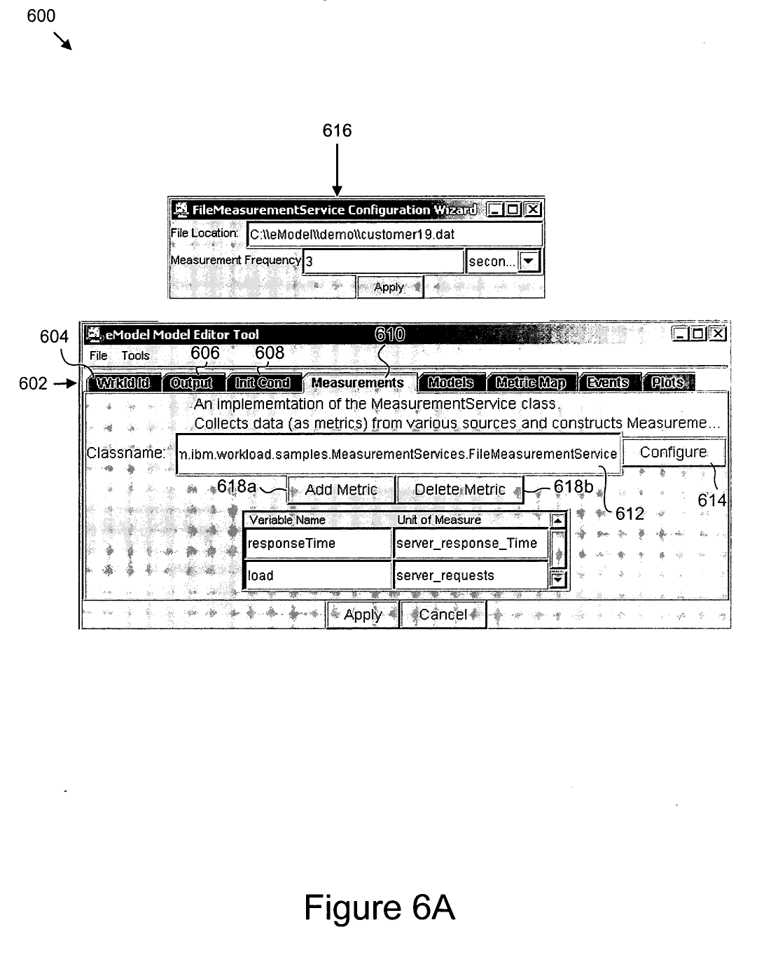

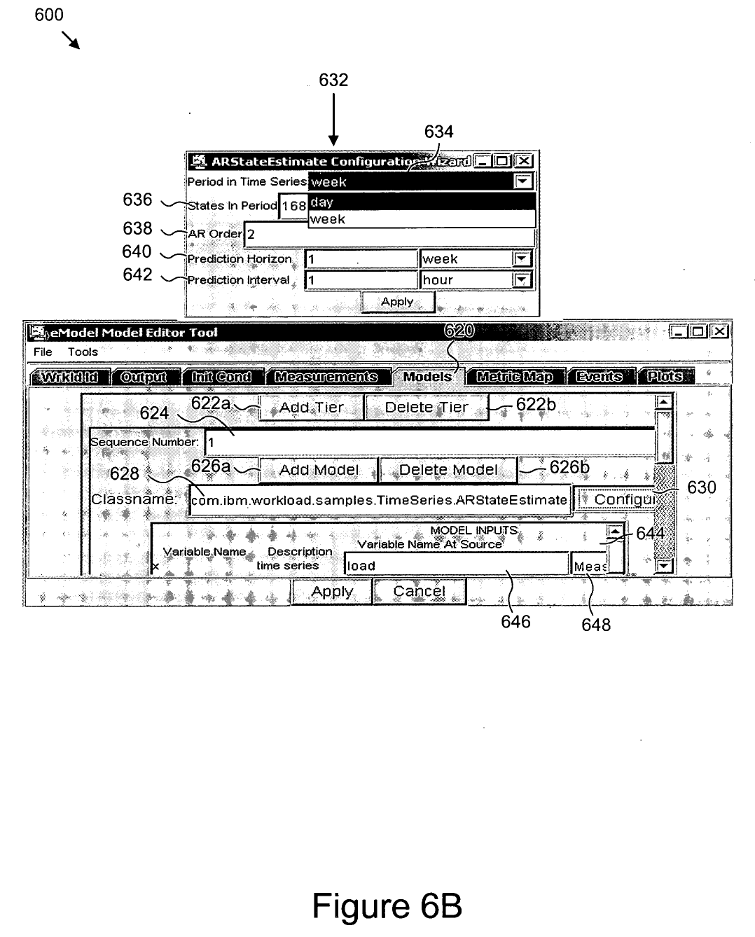

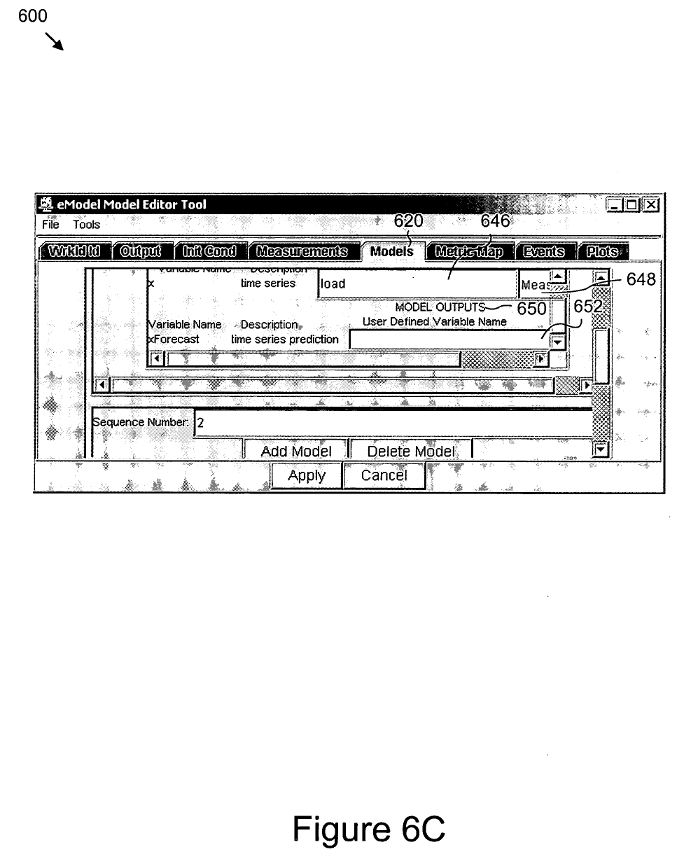

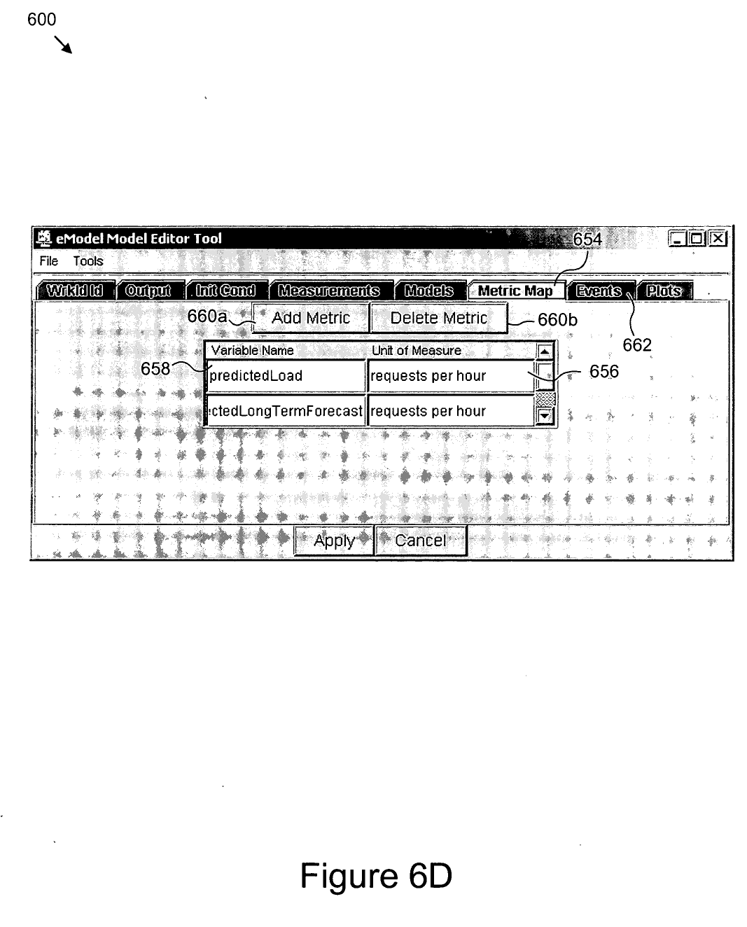

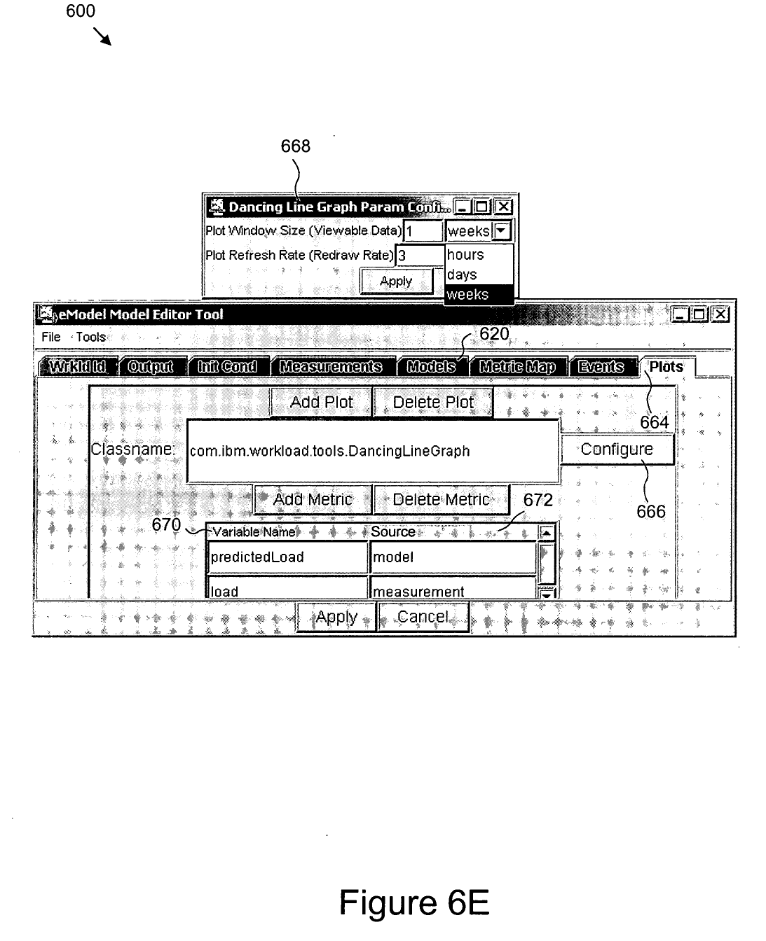

FIG. 6A illustrates one embodiment of an editor 600 for configuring a workload object 226 which is referred to by a user 212 as a model. The editor 600 comprises a tabbed interface 602. Those of skill in the art will appreciate the various kinds of edit boxes, buttons, and other user interface components that may be used on the tabs of the tabbed interface 602 to collect the necessary information. Select tabs will now be described.

A workload identifier tab 604 comprises an identification module that allows a user 212 to enter an identifier for the data and model flow 202 that will be embodied in a workload object 226. This same identifier may also be used to uniquely identify the workload object 226.

An output tab 606 allows a user 212 to identify where output data from the workload object 226 are to be stored. Typically, the output data comprises one or more files. Consequently, the output tab 606 captures a file name and path. An initial conditions tab 608 allows a user 212 to define one or more initial values that may be required by one or more of the models 224 of the workload object 226.

A measurements tab 610 (measurement module) allows a user to designate a software class configured to serve as a data collection module 218. The software class may be predefined or user-defined. To designate the software class, a user 212 may type in a path and file name in edit box 612 for the source code of the software class. Once selected, a configure button 614 generates a pop-up 616 that includes configuration parameters as defined within the designated software class. For example, the software class “FileMeasurementService” may require a file name and path to source data as well as an indication of the frequency for collecting the measurement information “3 seconds.” In addition, the measurement tab 610 includes buttons 618a,b for adding and deleting metrics, variables and associated units of measure, that are associated with the designated data collection module 218.

FIG. 6B illustrates a top-half of a model tab 620 that provides a model module for designating at least one model 224 that uses the performance data 306. As mentioned above, the present invention allows models 224 organized in a hierarchy to be executed in series. Alternatively, or in addition, models 224 on the same level or tier of a hierarchy may be executed in parallel. Consequently, the model tab 620 includes add tier and delete tier buttons 622a,b. For each tier, a sequence 624 for execution of the tier may be defined. Buttons 626a,b allow for models 224 to be added or deleted from tier. For each model 224, a class name 628 is required to identify the source code for the class that defines the model 224.

A configuration button 630 allows different coefficients and variables for the model 224 to be set or edited. In FIG. 6B, a pop-up window 632 allows a user 212 to designate various parameters that are specific to the particular model 224 defined in the class name 628. For example, with a time series model 224, the parameters may include the time series period 634, states in the period 636, the AR order 638, the prediction horizon 640, and the prediction interval 642.

Next, the model tab 620 allows for model inputs 644 to be identified by the name of the variable and the source of the variable. The variable name at the source 646 identifies the variable name in the data collection module 304 that is to be one of the input variables for this model 224. The source 648 of the variable may be either “measurement” or “model.” If the source 648 is “measurement,” the variable is to be retrieved from a measurement object passed by the data collection module 304. If the source 648 is “model,” the variable is to be retrieved from an output variable of a model 224 in the same workload object 226 having the same variable name 646.

Referring now to FIG. 6C, the bottom-half of the model tab 620 is illustrated. A model output section 650 allows a user 212 to define one or more output variables 652 for the model 224. The output variables 652 may be used as a source of data for the data analysis module 222 or as inputs to another model 224 in the same workload object 226. FIG. 6C also illustrates by the sequence number “2” and the position of the scroll bar, that another model 224 is defined for the example workload object 226 depicted. Defining this second model 224 proceeds in similar manner to that described above.

FIG. 6D illustrates a metric map tab 654 that allows a user 212 to define a metric map. The metric map defines the units of measure 656 for variables 658 in the models 224. The units of measure 656 are used by the plot class to present analysis data. Buttons 660a,b allow metrics to be added and deleted from the metric map.

The events tab 662 allows a user 212 to define threshold values, conditions, and modules of one or more events that are to be executed if the model variables satisfy one or more of the conditions in view of the threshold values. Events may comprise notification of a system administrator. Alternatively, for an autonomous environment, the events may comprise execution of remedial measures to avoid degradation in overall system performance that has been anticipated by the modeling.

FIG. 6E illustrates a plots tab 664 which provides a plot module configured to allow a user 212 to designate a data analysis module 222 for use with this workload object 226. As discussed above, the data analysis module 222 is identified by a file and path name for the source code of the class that implements the data analysis module 222. The class may be predefined or user-defined. A configure button 666 allows a user 212 to set parameters specific to the designated data analysis module 222. For example, a pop-up window 668 allows the plot window size and plot refresh rate to be entered. The input variables 670 for the data analysis module 222 are defined as well as the source 672 for the variable. As with the models tab 620, the source 672 may comprise a model or a measurement object provided by the data collection module 218.

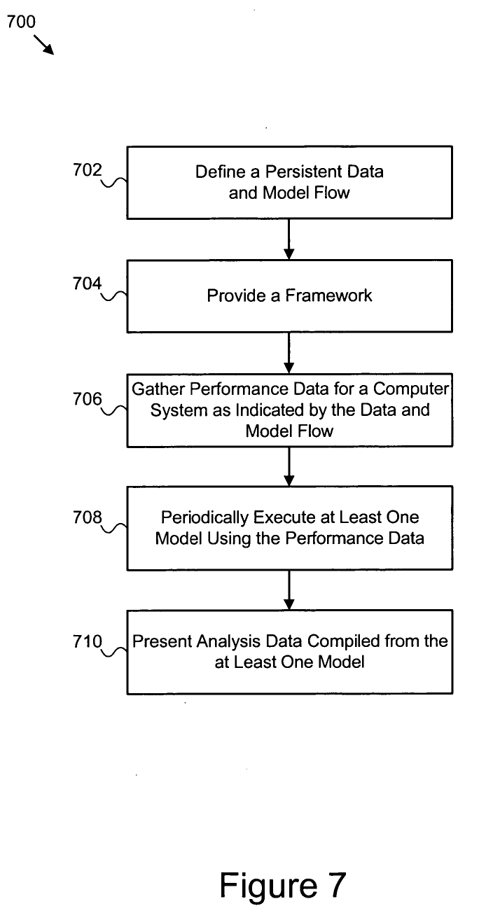

FIG. 7 illustrates a flow chart of a method 700 for modeling and analyzing a plurality of computing workloads according to one embodiment of the present invention. The method 700 begins by defining 702 a persistent data and model flow 202. In certain embodiments, the persistent data and model flow 202 is stored in an XML format by an editor 210. The editor 210 allows the data and model flow 202 to be stored in a machine readable format without the user 212 having to know the XML format.

Next, a framework 204 is provided 704 for managing the gathering of performance data 306, execution of models 224, and presentation of analysis data according to a predefined data and model flow 202. In certain embodiments, the framework 704 comprises a set of classes that provide an API for third-party applications. Then, performance data 306 associated with operation of the computer system 302 is gathered 706. The performance data 306 is gathered as indicated by the data and model flow 202. The performance data 306 may relate directly to performance of system components such as a CPU or relate to response time for requests from client systems 110.

Then, at least one model 224 that uses the performance data 306 is executed 708 periodically. Alternatively, the at least one model 224 may be executed in response to a data collection module 218 making updated performance data 306 available. In certain embodiments, a plurality of models 224 are executed in series, in parallel, or as part of a hierarchy such that a complete analysis of a computer systems' performance may be conducted. The order of operation, parameters, and designation of models 224 is defined in the data and model flow 202. Finally, analysis data compiled from the at least one model 224 is presented 710 to a user 212 for interpretation and analysis. Preferably, the analysis data is plotted using a predefined or user-defined data analysis module 222.

In summary, the present invention provides an apparatus, system, and method for modeling and analyzing a plurality of computing workloads. The present invention allows modeling and analysis using a plurality of models organized to be executed independently, in parallel, or in a hierarchical relationship. The present invention provides for ready use as a stand-alone, machine independent, and operating system independent software application as well as an API for use in third-party applications such as a conventional computer system monitoring and analysis tool. computer system modeling in a single software application.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for modeling and analyzing a plurality of computing workloads, comprising:
a data collection module configured to gather performance data associated with the operation of a computer system;
a modeling module configured to execute at least one model that uses the gathered performance data;
a data analysis module configured to present analysis data compiled from the modeling module; and
a framework configured to manage the data collection module, the modeling module, and the data analysis module in response to a predefined data and model flow.

2. The apparatus of claim 1, wherein the framework is configured to selectively operate a predefined data collection module or a user-defined data collection module in response to the predefined data and model flow.

3. The apparatus of claim 1, wherein the framework is configured to selectively operate a predefined model or a user-defined model in response to the predefined data and model flow.

4. The apparatus of claim 1, wherein the framework is configured to selectively operate a predefined data analysis module or a user-defined data analysis module in response to the predefined data and model flow.

5. The apparatus of claim 1, wherein the framework is integrated within a predefined user interface.

6. The apparatus of claim 1, wherein the framework is integrated within a third-party application.

7. The apparatus of claim 1, wherein the modeling module is further configured to execute a plurality of models such that output data from a first model serves as input data for a second model in a hierarchy of models.

8. The apparatus of claim 1, wherein the modeling module is further configured to execute a plurality of models in parallel.

9. The apparatus of claim 1, wherein the framework is configured to implement the predefined data and model flow at least in part by defining a workload software object from a persistent data structure, the workload software object comprising parameters for the data collection module, modeling module, and data analysis module.

10. The apparatus of claim 1, further comprising an editor configured to allow a user to define and store the predefined data and model flow.

11. The apparatus of claim 1, wherein the at least one model is selected from the group of models consisting of a workload prediction model, a performance analysis model, an optimization model, and a user-defined model.

12. An editor for defining, revising, and storing a data and model flow for modeling and analyzing a plurality of computing workloads, comprising:
an identification module for gathering an identifier for a data and model flow;
a measurement module for designating a data collection module configured to gather performance data associated with the operation of a computer system;
a model module for designating at least one model that uses the gathered performance data;
a metric map for defining model variables required to analyze analysis data compiled from the at least one model;
a plot module for designating a data analysis module configured to present analysis data compiled from the at least one model.

13. The editor of claim 12, further comprising a storage module configured to store and retrieve the data and model flow from a persistent data structure.

14. The editor of claim 13, wherein the persistent data structure comprises an eXtensible Markup Language (XML) file.

15. The editor of claim 13, wherein the persistent data structure comprises a database.

16. A system for modeling and analyzing computing operations for a computer system, comprising:
a computer system for which computer workloads are to be monitored and analyzed;
a data collection module in communication with the computer system and configured to gather performance data associated with the operation of the computer system;
a run-time manager configured to periodically poll the data collection module and in response to the data collection module providing the gathered performance data, execute one or more models in a workload module associated with the gathered performance data;
a data analysis module configured to present analysis data compiled from the workload module in response to an event.

17. The system of claim 16, further comprising a user interface configured to execute one or more workload modules within the run-time manager in response to a user request, each workload modules defining a data and model flow specifically designed for the computer system, the data and model flow defined within a persistent data structure.

18. The system of claim 16, wherein the event comprises analysis data that fails to satisfy a threshold value.

19. The system of claim 16, wherein the event comprises a user request for analysis data, the data analysis module presenting the analysis data to a user by way of a user-definable plotting module.

20. The system of claim 16, further comprising an event handler that executes a predefined action in response to the event.

21. An application programming interface (API) for real-time modeling and analyzing of computing workloads, comprising:
a measurement software class configured to gather performance data associated with the operation of a computer system;
a workload software class that defines a data and model flow associated with the computer system, the workload software class comprising one or more model software classes that utilize the gathered performance data to model attributes of the computer system; and
a run-time manager software class configured to periodically poll for measurement objects instantiated from the measurement software class and execute one or more model objects instantiated from the one or more model software classes in response to the data and model flow defined by one or more workload objects.

22. The API of claim 21, further comprising a real-time interface module configured to start and stop execution of one or more workload objects.

23. The API of claim 21, wherein the interface is further configured to present analysis data compiled by a plot object instantiated from a plot class, the analysis data associated with a specific workload object identified by a user.

24. A method for modeling and analyzing a plurality of computing workloads, comprising:
gathering performance data associated with the operation of a computer system;
executing at least one model that uses the gathered performance data;
presenting analysis data compiled from the at least one model; and
providing a framework configured to manage the gathering of performance data, the execution of the at least one model, and the presentation of the analysis data in response to a predefined data and model flow.

25. The method of claim 24, wherein the framework is executed from within a third-party application.

26. An article of manufacture comprising a program storage medium readable by a processor and embodying one or more instructions executable by a processor to perform a method for modeling and analyzing a plurality of computing workloads, the method comprising:
gathering performance data associated with the operation of a computer system;
executing at least one model that uses the gathered performance data;
presenting analysis data compiled from the at least one model; and
providing a framework configured to manage the gathering of performance data, the execution of the at least one model, and the presentation of the analysis data in response to a predefined data and model flow.

27. An apparatus for modeling and analyzing a plurality of computing workloads, comprising:
means for gathering performance data associated with the operation of a computer system;
means for executing at least one model that uses the gathered performance data;
means for presenting analysis data compiled from the at least one model; and
means for providing a framework configured to manage the gathering of performance data, the execution of the at least one model, and the presentation of the analysis data in response to a predefined data and model flow.

28. A method for modeling and analyzing a plurality of computing workloads, said method comprising:
specifying a data and model flow for monitoring a computer system;
invoking a modeling and analysis utility, wherein the data and model flow defines performance data that is collected and models that are executed periodically using the performance data to compile analysis data representative of results from one or more of the models; and
receiving a real-time graphical representation of the analysis data from the modeling and analysis utility, in response to an event.

29. The method of claim 28, wherein the event comprises analysis data that fails to satisfy a threshold value.

30. The method of claim 28, wherein the event comprises a user request, the modeling and analysis utility presenting the graphical representation of the analysis data to a user by way of a user-defined plotting module.
